(19) United States
(12) Patent Application Publication
(10) Pub. No.: US 2026/0326658 A1
(43) Pub. Date: Oct. 22, 2026

(54) ADAPTIVE DRIVING BEAM HEADLAMP CONTROL SYSTEM BASED ON ULTRA-WIDEBAND TECHNOLOGY

(71) Applicant: VOGILI Inc., Hsinchu City (TW)

(72) Inventors: CHUN-HSIEN KUO, Hsinchu City (TW); YUAN-HUEI CHANG, Hsinchu City (TW); SHIH-YU LEE, Hsinchu City (TW)

(21) Appl. No.: 19/632,517

(22) Filed: Mar. 30, 2026

(30) Foreign Application Priority Data
Mar. 31, 2025 (TW) 114112238

(51) Int. Cl. B60Q 1/08; G01S 13/02; G01S 13/89; G07C 5/08; H04B 1/7163; H04W 4/48; H04W 4/80; H05B 47/115

(52) U.S. Cl. CPC B60Q 1/085; G01S 13/0209; G01S 13/89; G07C 5/0808; H04B 1/7163; H04W 4/48; H04W 4/80; H05B 47/115; B60Q 2300/42; B60Q 2400/20

(57) ABSTRACT

An adaptive driving beam headlamp control system based on ultra-wideband connection includes an ultra-wideband local area network controller and a modular adaptive driving beam headlamp. The ultra-wideband local area network controller includes an ultra-wideband chip, a Bluetooth chip, and a control unit. The modular adaptive driving beam headlamp includes a matrix LED headlamp, an imaging radar unit, and a first sub-ultra-wideband chip. The control unit correspondingly generates a control signal according to at least real-time driving environment information generated by the imaging radar unit, and the control signal is transmitted to the matrix LED headlamp via the ultra-wideband connection, so that the matrix LED headlamp is controlled to emit a light beam based on an active safety mode.

### CROSS-REFERENCE TO RELATED PATENT APPLICATION

This application claims the benefit of priority to Taiwan Patent Application No. 114112238, filed on Mar. 31, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a driving beam headlamp control system, and more particularly to an adaptive driving beam headlamp control system based on ultra-wideband connection.

### BACKGROUND OF THE DISCLOSURE

Currently, adaptive driving beam headlamp control systems on the market can generally be divided into two types: a factory-installed product and an aftermarket-installed product. The factory-installed product refers to original equipment (OE) that is in-built before a vehicle is shipped from a factory. The aftermarket-installed product is selected from various products according to individual requirements, and is installed after the vehicle is shipped from the factory. However, since the wiring for the aftermarket (AM) adaptive driving beam headlamp control system needs to be re-arranged, complex wiring can cause implementation difficulties and incur high labor costs.

### SUMMARY OF THE DISCLOSURE

In response to the above-referenced technical inadequacies, the present disclosure provides an adaptive driving beam headlamp control system based on ultra-wideband connection.

In order to solve the above-mentioned problems, one of the technical aspects adopted by the present disclosure is to provide an adaptive driving beam headlamp control system based on ultra-wideband connection, which is adapted to be installed on a vehicle. The adaptive driving beam headlamp control system includes an ultra-wideband local area network controller and a modular adaptive driving beam headlamp. The ultra-wideband local area network controller includes an ultra-wideband chip, a Bluetooth chip, and a control unit. The ultra-wideband chip is configured for management and connection of an ultra-wideband local area network of the vehicle. The Bluetooth chip is configured for connection of an external apparatus. The control unit is coupled to the ultra-wideband chip and the Bluetooth chip, and is configured for controlling connection and transmission of each of the ultra-wideband chip and the Bluetooth chip. The modular adaptive driving beam headlamp includes a matrix LED headlamp, an imaging radar unit, and a first sub-ultra-wideband chip. The matrix LED headlamp is configured for emitting a light beam. The imaging radar unit is configured for detecting an environment in front of the vehicle, so as to generate real-time driving environment information. The first sub-ultra-wideband chip is coupled to the matrix LED headlamp and the imaging radar unit, and the ultra-wideband connection is established between the first sub-ultra-wideband chip and the ultra-wideband chip. The real-time driving environment information generated by the imaging radar unit is transmitted to the control unit via the ultra-wideband connection of the first sub-ultra-wideband chip and the ultra-wideband chip. The control unit correspondingly generates a first control signal according to at least the real-time driving environment information, and the first control signal is transmitted to the matrix LED headlamp via the ultra-wideband connection of the ultra-wideband chip and the first sub-ultra-wideband chip, so as to control the matrix LED headlamp to emit the light beam based on an active safety mode.

In one of the possible or preferred embodiments, the imaging radar unit is a 4D imaging radar, and the real-time driving environment information generated by the imaging radar unit includes an orientation, a distance, a velocity, and a height of a target in front of the vehicle.

In one of the possible or preferred embodiments, the control unit is configured to receive a vehicle diagnostic signal (on-board diagnostics (OBD) signal) of the vehicle and obtain real-time vehicle information from the vehicle diagnostic signal, and the real-time vehicle information includes a driving velocity and an engine rotational speed of the vehicle. The control unit correspondingly generates the first control signal according to the real-time driving environment information and the real-time vehicle information, and the first control signal is transmitted to the matrix LED headlamp via the ultra-wideband connection of the ultra-wideband chip and the first sub-ultra-wideband chip, so as to control the matrix LED headlamp to emit the light beam based on the active safety mode.

In one of the possible or preferred embodiments, the adaptive driving beam headlamp control system further includes an image recognition device. The image recognition device includes an image capturing unit, an image recognition unit, and a second sub-ultra-wideband chip. The image capturing unit is configured for capturing an image, and the image recognition unit is coupled to the image capturing unit and the second sub-ultra-wideband chip. The image recognition unit is configured for receiving the image captured by the image capturing unit and performing recognition to correspondingly generate real-time image recognition information, and the real-time image recognition information is transmitted to the control unit via the ultra-wideband connection of the second sub-ultra-wideband chip and the ultra-wideband chip, so that the control unit correspondingly generates the first control signal according to the real-time driving environment information, the real-time vehicle information, and the real-time image recognition information, and the first control signal is transmitted to the matrix LED headlamp via the ultra-wideband connection of the ultra-wideband chip and the first sub-ultra-wideband chip for controlling the matrix LED headlamp to emit the light beam based on the active safety mode.

In one of the possible or preferred embodiments, the adaptive driving beam headlamp control system further includes an augmented reality head-up display. The augmented reality head-up display includes a picture generation unit and a third sub-ultra-wideband chip. The picture generation unit is coupled to the third sub-ultra-wideband chip, and the picture generation unit is configured for receiving the real-time image recognition information, the real-time driving environment information, or the real-time vehicle information via the ultra-wideband connection of the third sub-ultra-wideband chip and the ultra-wideband chip, so as to correspondingly generate an image message for a driver of the vehicle to see.

In one of the possible or preferred embodiments, the control unit uses the Bluetooth chip to identify the external apparatus that is to be connected for determination of an authorized or unauthorized user. Upon determination of the authorized user, a second control signal is correspondingly generated and transmitted to the matrix LED headlamp via the ultra-wideband connection of the ultra-wideband chip and the first sub-ultra-wideband chip, so as to control the matrix LED headlamp to emit the light beam for a period of time based on a welcome mode.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view illustrating an adaptive driving beam headlamp control system being installed in a vehicle according to one embodiment of the present disclosure;

FIG. 2 is a schematic view of a modular adaptive driving beam headlamp according to one embodiment of the present disclosure;

FIG. 3 is a functional block diagram of the adaptive driving beam headlamp control system according to one embodiment of the present disclosure;

FIG. 4 is a schematic view illustrating the adaptive driving beam headlamp control system being installed in the vehicle according to one embodiment of the present disclosure;

FIG. 5 is a functional block diagram of the adaptive driving beam headlamp control system according to one embodiment of the present disclosure;

FIG. 6 is a schematic view illustrating the adaptive driving beam headlamp control system being installed in the vehicle according to one embodiment of the present disclosure; and

FIG. 7 is a functional block diagram of the adaptive driving beam headlamp control system according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

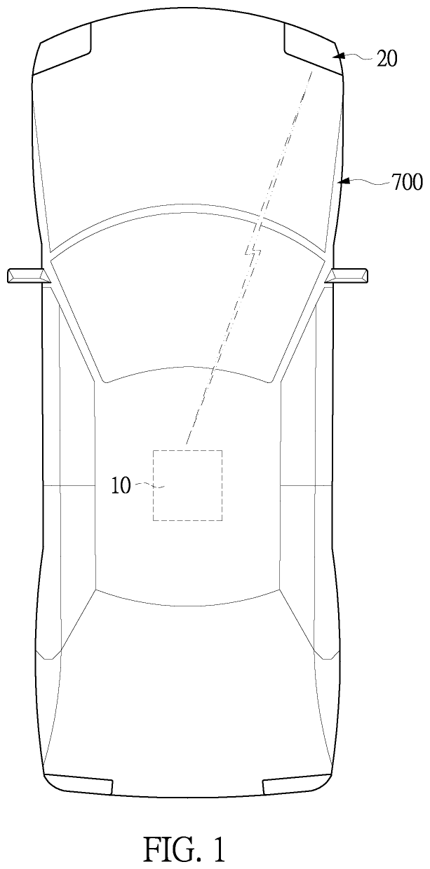

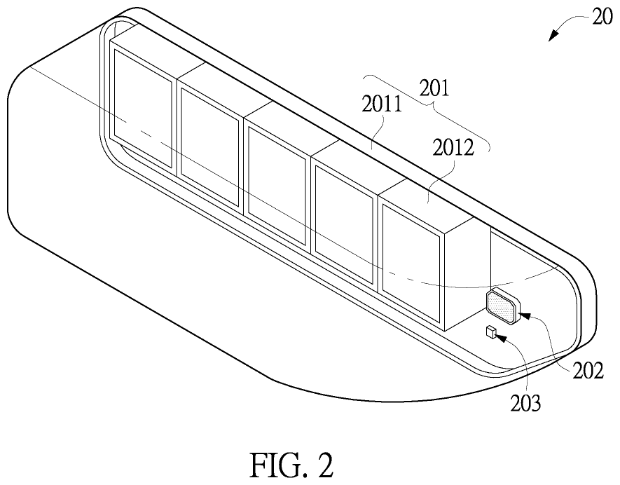

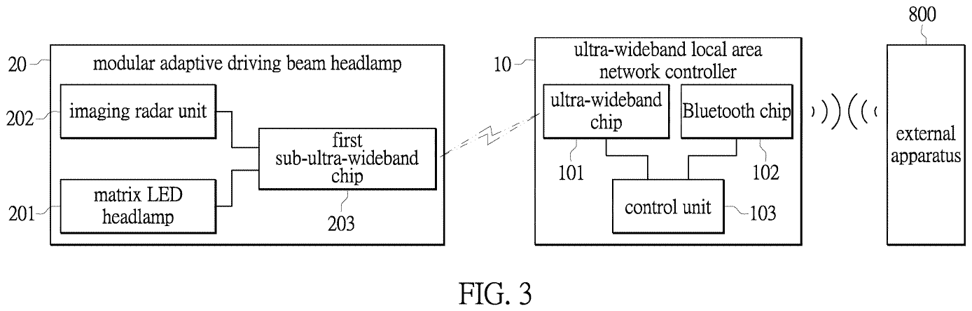

Referring to FIG. 1, FIG. 2, and FIG. 3, one embodiment of the present disclosure provides an adaptive driving beam headlamp control system based on ultra-wideband connection (hereunder referred to as an adaptive driving beam headlamp control system for short), which is adapted to be installed on a vehicle 700. The vehicle 700 can be a car, a heavy-duty truck, a large bus, etc., but is not limited thereto. The adaptive driving beam headlamp control system of the present embodiment essentially includes an ultra-wideband local area network controller 10 and at least one modular adaptive driving beam headlamp 20.

The ultra-wideband local area network controller 10 can be on-board diagnostics (OBD) of the vehicle 700 or a part thereof, or can be a port connected to the OBD. In addition, the ultra-wideband local area network controller 10 can also be integrated with those that are in-built (e.g., an in-vehicle host and a digital dashboard) during shipment from the factory.

In the present embodiment, as shown in FIG. 3, the ultra-wideband local area network controller 10 includes an ultra-wideband chip 101, a Bluetooth chip 102, and a control unit 103.

The ultra-wideband (UWB) chip 101 is configured for management and connection of an ultra-wideband local area network of the vehicle 700. Specifically, the ultra-wideband chip 101 uses an ultra-wideband technology to achieve management and connection of the ultra-wideband local area network of the vehicle 700. The ultra-wideband technology is a wireless communication technology, has characteristics of low power consumption and high-speed transmission, and can provide low latency data transmission that is as high as 27 Mbps. Accordingly, the ultra-wideband chip 101 and all UWB components in the ultra-wideband local area network of the vehicle 700 can perform high-speed and safe data transmission via the ultra-wideband technology, and an extremely low power consumption is maintained at the same time. The control unit 103 is coupled to the ultra-wideband chip 101, and is configured for controlling connection of the ultra-wideband local area network jointly formed by the ultra-wideband chip 101 and all the UWB components and transmission of data or signals.

The Bluetooth chip 102 is configured for connection of an external apparatus 800, such as connection with a smartphone, a tablet computer, etc. Specifically, the Bluetooth chip 102 uses a Bluetooth technology to achieve connection with the external apparatus 800. The control unit 103 is coupled to the Bluetooth chip 102, and is configured for controlling connection of the Bluetooth chip 102 and the external apparatus 800 and transmission of data or signals. The control unit 103 can further use the Bluetooth chip 102 to identify the external apparatus 800, so as to identify an identity of a vehicle user for determining whether or not the vehicle user is an authorized user (e.g., a vehicle owner).

In the present embodiment, the control unit 103 can be a central processing unit (CPU) or a system on chip (SoC). In addition, the control unit 103 is configured for receiving or processing the vehicle diagnostic signal (OBD signal) and obtaining real-time vehicle information from the vehicle diagnostic signal. The real-time vehicle information can include a driving velocity, an engine rotational speed, a cooling water temperature, a battery voltage, and other information.

In the present embodiment, the modular adaptive driving beam headlamp 20 is configured as one of the UWB components in the ultra-wideband local area network of the vehicle 700, and a quantity of the modular adaptive driving beam headlamp 20 installed on the vehicle 700 is two. For convenience of illustration, only one modular adaptive driving beam headlamp 20 is described below. The modular adaptive driving beam headlamp 20 of the present embodiment includes a matrix LED headlamp 201, an imaging radar unit 202, and a first sub-ultra-wideband chip 203.

The matrix LED headlamp 201 is installed at a front side of the vehicle 700. As shown in FIG. 2, the matrix LED headlamp 201 includes a lamp housing 2011 and a matrix LED element 2012 disposed in the lamp housing 2011. Moreover, the lamp housing 2011 can be an aftermarket-installed lamp housing that corresponds in appearance and contour to a factory-installed lamp housing.

The imaging radar unit 202 is disposed in the lamp housing 2011 of the matrix LED headlamp 201. The imaging radar unit 202 can be disposed in a region outside of the matrix LED element 2012 and be coupled to a power source of the matrix LED element 2012, and the power source can be converted from a generator or a battery of the vehicle 700. The imaging radar unit 202 can be triggered after the vehicle 700 is started, and can use an imaging radar technology to emit a radar detection signal and receive a corresponding reflection signal, thereby detecting an environment in front of the vehicle 700. Due to using the imaging radar technology, the imaging radar unit 202 has an ability to accurately measure target distances and velocities, and is not negatively affected by environment conditions such as rain, fog, and glare. As such, the environment in front of the vehicle 700 can be properly detected.

Specifically, the imaging radar unit 202 of the present embodiment is a 4D imaging radar that can detect the environment in front of the vehicle 700 for generating real-time driving environment information. The real-time driving environment information includes four-dimensional data of an orientation, a distance, a velocity, and a height of a target. Furthermore, a dynamic range of the imaging radar unit 202 is sufficiently high, so that an object that is smaller and farther away can be detected, and a contour of the target can be analyzed, thereby allowing a radar to achieve an imaging function. This is what a conventional 3D millimeter-wave radar fails to achieve.

The first sub-ultra-wideband chip 203 of the modular adaptive driving beam headlamp 20 is disposed in the lamp housing 2011 of the matrix LED headlamp 201, and can be disposed in a region outside of the matrix LED element 2012 and the imaging radar unit 202. The first sub-ultra-wideband chip 203 is coupled to the imaging radar unit 202 and the matrix LED headlamp 201, and the ultra-wideband connection is established between the first sub-ultra-wideband chip 203 and the ultra-wideband chip 101 via the ultra-wideband technology, so that the real-time driving environment information generated by the imaging radar unit 202 is transmitted to the control unit 103 via the ultra-wideband connection of the first sub-ultra-wideband chip 203 and the ultra-wideband chip 101. Furthermore, the control unit 103 correspondingly generates a first control signal according to at least the real-time driving environment information (i.e., according to the real-time driving environment information and/or the real-time vehicle information), and the first control signal is transmitted to the matrix LED headlamp 201 via the ultra-wideband connection of the ultra-wideband chip 101 and the first sub-ultra-wideband chip 203, so as to control a light beam emitted by the matrix LED headlamp 201.

In one example, the control unit 103 can obtain the distance, the velocity, the orientation, and the height of the target (e.g., an oncoming vehicle) according to the real-time driving environment information. Furthermore, the control unit 103 can obtain a velocity of the vehicle 700 according to the real-time vehicle information, and the first control signal is correspondingly generated and transmitted to the matrix LED headlamp 201 via the ultra-wideband connection of the ultra-wideband chip 101 and the first sub-ultra-wideband chip 203, so as to control the matrix LED headlamp 201 to emit the light beam based on an active safety mode. That is, a luminance of the light beam emitted by the matrix LED headlamp 201 is correspondingly and gradually decreased according to the distance or the velocity of the oncoming vehicle, or an angle of the light beam emitted by the matrix LED headlamp 201 is correspondingly and gradually adjusted downward or upward according to the orientation or the height of the oncoming vehicle. In this way, an overly-bright light beam is prevented from dazzling a driver of the oncoming vehicle and causing hidden dangers.

In another example, the control unit 103 can use the Bluetooth chip 102 to identify the external apparatus 800 that is to be connected, so as to identify the identity of the vehicle user for determining whether or not the vehicle user is the authorized user. When the vehicle user is determined to be the authorized user (e.g., the vehicle owner), a second control signal is correspondingly generated and transmitted to the matrix LED headlamp 201 via the ultra-wideband connection of the ultra-wideband chip 101 and the first sub-ultra-wideband chip 203, so as to control the matrix LED headlamp 201 to emit the light beam for a period of time based on a welcome mode. That is, the matrix LED headlamp 201 is configured to gradually emit the light beam on a zone-by-zone basis or enable the light beam to flicker non-stop within a predetermined time. In this way, the matrix LED headlamp 201 can be used as a welcome lamp.

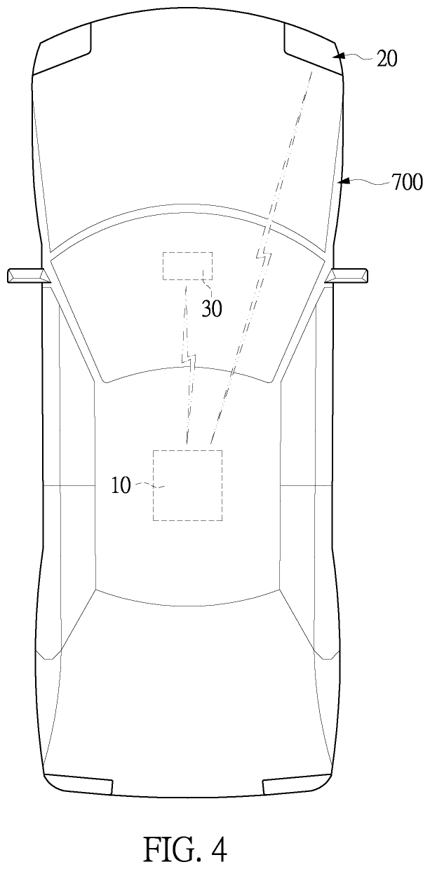

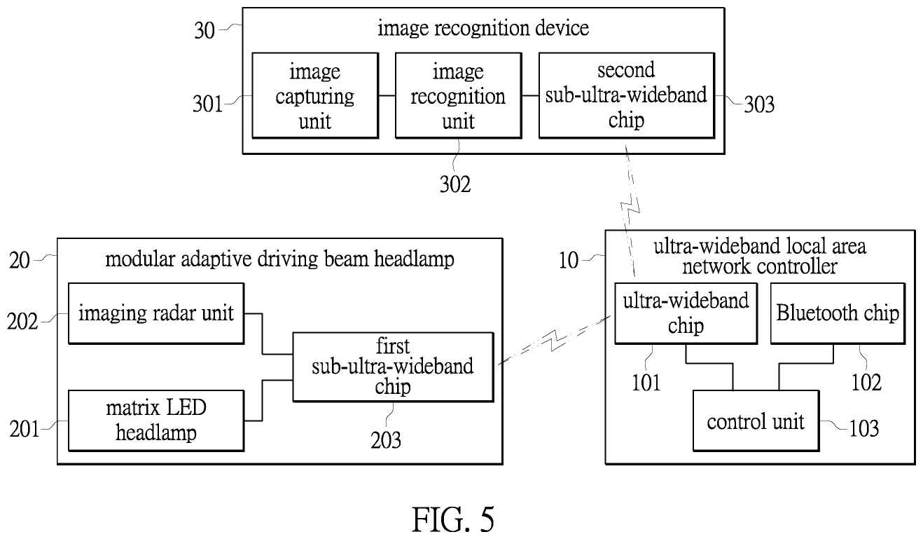

In one embodiment, referring to FIG. 4 and FIG. 5, the adaptive driving beam headlamp control system can further include an image recognition device 30. The image recognition device 30 can be added into the ultra-wideband local area network of the vehicle 700 via the ultra-wideband technology, and acts as one of the UWB components in the ultra-wideband local area network of the vehicle 700.

In the present embodiment, the image recognition device 30 includes an image capturing unit 301, an image recognition unit 302, and a second sub-ultra-wideband chip 303.

For example, the image capturing unit 301 is implemented as a camera, and the image recognition unit 302 is implemented as an ARM image processing chip or a DSP image processing chip. The image capturing unit 301 is configured for capturing an image, and the image recognition unit 302 is coupled to the image capturing unit 301 and the second sub-ultra-wideband chip 303. The image recognition unit 302 is configured for receiving the image captured by the image capturing unit 301 and performing recognition to correspondingly generate real-time image recognition information, and the real-time image recognition information is transmitted to the control unit 103 via the ultra-wideband connection of the second sub-ultra-wideband chip 303 and the ultra-wideband chip 101, so that the control unit 103 correspondingly generates the first control signal according to the real-time driving environment information, the real-time vehicle information, and the real-time image recognition information, and the first control signal is transmitted to the matrix LED headlamp 201 via the ultra-wideband connection of the ultra-wideband chip 101 and the first sub-ultra-wideband chip 203 for controlling the matrix LED headlamp 201 to emit the light beam based on the above-mentioned active safety mode.

Specifically, the image recognition unit 302 can perform recognition on the image captured by the image capturing unit 301 via an image recognition technology, such as object recognition (R-CNN or Mask R-CNN). In this way, whether or not there is the oncoming vehicle in front of the vehicle 700 or whether or not pedestrians or animals are crossing the road can be determined, and the real-time image recognition information can be correspondingly generated according to a recognition result and be transmitted to the control unit 103 via the ultra-wideband technology. Apart from using the real-time driving environment information transmitted by the imaging radar unit 202 via the ultra-wideband technology, the control unit 103 can further use the real-time image recognition information transmitted by the image recognition unit 302 via the ultra-wideband technology to make a comprehensive determination, so as to correspondingly generate and transmit the first control signal to the matrix LED headlamp 201 via the ultra-wideband technology. Accordingly, the matrix LED headlamp 201 can be controlled to emit the light beam based on the above-mentioned active safety mode.

Since the image recognition unit 302 supplements visual features that include lane markings, traffic signs, traffic signals (traffic lights), and other details, and the imaging radar unit 202 precisely provides the orientation, the distance, the velocity, and the height of the object, complementarity can be increased, and reliability can be enhanced with less misjudgment. In addition, a real-time response can be achieved via the ultra-wideband technology, thereby improving safety of the driver.

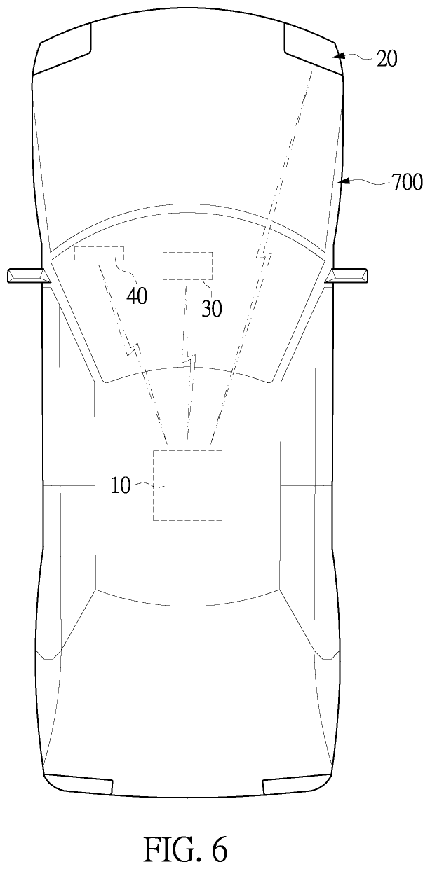

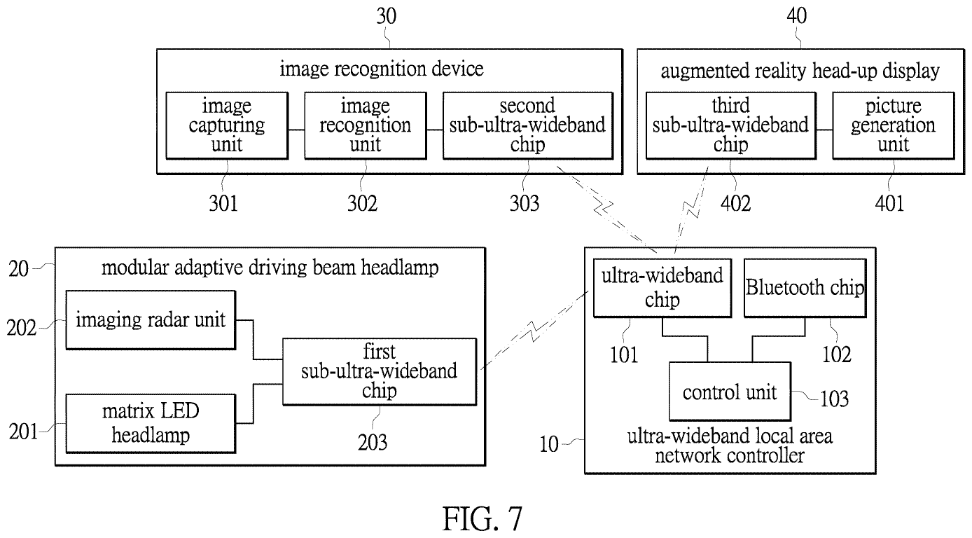

In one embodiment, referring to FIG. 6 and FIG. 7, the adaptive driving beam headlamp control system can further include an augmented reality head-up display (AR HUD) 40. The augmented reality head-up display 40 can be added into the ultra-wideband local area network of the vehicle 700 via the ultra-wideband technology, and acts as one of the UWB components in the ultra-wideband local area network of the vehicle 700.

In the present embodiment, the augmented reality head-up display 40 includes a picture generation unit (PGU) 401 and a third sub-ultra-wideband chip 402. Naturally, the augmented reality head-up display 40 can further include elements that can enable operations of the augmented reality head-up display 40, such as mirrors and backlights.

The picture generation unit 401 is coupled to the third sub-ultra-wideband chip 402. By using the real-time image recognition information, the real-time driving environment information, or the real-time vehicle information received via the third sub-ultra-wideband chip 402, the picture generation unit 401 is configured for generating an image message that can be reflected onto a windshield of the vehicle 700. Accordingly, the eyes of the driver can see the image message on the windshield in real time without being distracted during driving, thereby improving driving safety.

### Beneficial Effects of the Embodiments

In conclusion, the adaptive driving beam headlamp control system based on the ultra-wideband connection provided by the present disclosure includes an ultra-wideband local area network controller and a modular adaptive driving beam headlamp. The ultra-wideband local area network controller includes an ultra-wideband chip, a Bluetooth chip, and a control unit. The modular adaptive driving beam headlamp includes a matrix LED headlamp, an imaging radar unit, and a first sub-ultra-wideband chip. Real-time driving environment information generated by the imaging radar unit is transmitted to the control unit via the ultra-wideband connection of the first sub-ultra-wideband chip and the ultra-wideband chip. The control unit correspondingly generates a control signal according to at least the real-time driving environment information, and the control signal is transmitted to the matrix LED headlamp via the ultra-wideband connection of the ultra-wideband chip and the first sub-ultra-wideband chip, so as to control the matrix LED headlamp to emit a light beam based on an active safety mode. Hence, the modular adaptive driving beam headlamp of the present disclosure transmits the real-time driving environment information via the ultra-wideband technology, and the ultra-wideband local area network controller correspondingly transmits the control signal according to the real-time driving environment information with use of the ultra-wideband technology, so as to control the modular adaptive driving beam headlamp to emit the light beam based on the active safety mode. In this way, safety of a driver can be actively improved. Furthermore, when transmission is carried out via the ultra-wideband technology, there are advantages of low power consumption and high-speed transmission, and the issue of complex wiring can also be eliminated, thereby effectively reducing implementation difficulties and labor costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An adaptive driving beam headlamp control system based on ultra-wideband connection, adapted to be installed on a vehicle, the adaptive driving beam headlamp control system comprising:
an ultra-wideband local area network controller, including:
an ultra-wideband chip configured for management and connection of an ultra-wideband local area network of the vehicle;
a Bluetooth chip configured for connection of an external apparatus; and
a control unit coupled to the ultra-wideband chip and the Bluetooth chip, wherein the control unit is configured for controlling connection and transmission of each of the ultra-wideband chip and the Bluetooth chip; and
a modular adaptive driving beam headlamp, including:
a matrix LED headlamp configured for emitting a light beam;
an imaging radar unit configured for detecting an environment in front of the vehicle, so as to generate real-time driving environment information; and
a first sub-ultra-wideband chip, wherein the first sub-ultra-wideband chip is coupled to the matrix LED headlamp and the imaging radar unit, and the ultra-wideband connection is established between the first sub-ultra-wideband chip and the ultra-wideband chip;
wherein the real-time driving environment information generated by the imaging radar unit is transmitted to the control unit via the ultra-wideband connection of the first sub-ultra-wideband chip and the ultra-wideband chip; and wherein the control unit correspondingly generates a first control signal according to at least the real-time driving environment information, and the first control signal is transmitted to the matrix LED headlamp via the ultra-wideband connection of the ultra-wideband chip and the first sub-ultra-wideband chip, so as to control the matrix LED headlamp to emit the light beam based on an active safety mode.

2. The adaptive driving beam headlamp control system according to claim 1, wherein the imaging radar unit is a 4D imaging radar, and the real-time driving environment information generated by the imaging radar unit includes an orientation, a distance, a velocity, and a height of a target in front of the vehicle.

3. The adaptive driving beam headlamp control system according to claim 2, wherein the control unit is configured to receive a vehicle diagnostic signal of the vehicle and obtain real-time vehicle information from the vehicle diagnostic signal, and the real-time vehicle information includes a driving velocity and an engine rotational speed of the vehicle; and wherein the control unit correspondingly generates the first control signal according to the real-time driving environment information and the real-time vehicle information, and the first control signal is transmitted to the matrix LED headlamp via the ultra-wideband connection of the ultra-wideband chip and the first sub-ultra-wideband chip, so as to control the matrix LED headlamp to emit the light beam based on the active safety mode.

4. The adaptive driving beam headlamp control system according to claim 3, further comprising an image recognition device, wherein the image recognition device includes an image capturing unit, an image recognition unit, and a second sub-ultra-wideband chip, the image capturing unit is configured for capturing an image, and the image recognition unit is coupled to the image capturing unit and the second sub-ultra-wideband chip; and wherein the image recognition unit is configured for receiving the image captured by the image capturing unit and performing recognition to correspondingly generate real-time image recognition information, and the real-time image recognition information is transmitted to the control unit via the ultra-wideband connection of the second sub-ultra-wideband chip and the ultra-wideband chip, so that the control unit correspondingly generates the first control signal according to the real-time driving environment information, the real-time vehicle information, and the real-time image recognition information, and the first control signal is transmitted to the matrix LED headlamp via the ultra-wideband connection of the ultra-wideband chip and the first sub-ultra-wideband chip for controlling the matrix LED headlamp to emit the light beam based on the active safety mode.

5. The adaptive driving beam headlamp control system according to claim 4, further comprising an augmented reality head-up display, wherein the augmented reality head-up display includes a picture generation unit and a third sub-ultra-wideband chip, the picture generation unit is coupled to the third sub-ultra-wideband chip, and the picture generation unit is configured for receiving the real-time image recognition information, the real-time driving environment information, or the real-time vehicle information via the ultra-wideband connection of the third sub-ultra-wideband chip and the ultra-wideband chip, so as to correspondingly generate an image message for a driver of the vehicle to see.

6. The adaptive driving beam headlamp control system according to claim 1, wherein the control unit uses the Bluetooth chip to identify the external apparatus that is to be connected for determination of an authorized or unauthorized user; and wherein, upon determination of the authorized user, a second control signal is correspondingly generated and transmitted to the matrix LED headlamp via the ultra-wideband connection of the ultra-wideband chip and the first sub-ultra-wideband chip, so as to control the matrix LED headlamp to emit the light beam for a period of time based on a welcome mode.
